(19) United States
(12) Patent Application Publication
(10) Pub. No.: US 2024/0184515 A1
(43) Pub. Date: Jun. 6, 2024

(54) Vocal Attenuation Mechanism in On-Device App

(71) Applicant: Apple Inc., Cupertino, CA (US)

(72) Inventor: Matthias Mauch, London (GB)

(21) Appl. No.: 18/527,845

(22) Filed: Dec. 4, 2023

Related U.S. Application Data
(60) Provisional application No. 63/385,979, filed on Dec. 4, 2022.

(51) Int. Cl. G06F 3/16

(52) U.S. Cl. CPC G06F 3/165

(57) ABSTRACT

Generating vocal attenuation for a media item having an audio component includes obtaining the media item on a client device and modifying the media item to create a modified media item with an isolated audio track. The modified media item is created using an attenuation model via a separator network on the client's device. During playback, functionality is provided to a listener to modify characteristics of the isolated track, such as volume levels. Graphical representations of media items are denoted with visual indicators (e.g., icons) when vocal attenuation for the media item is available. Vocal attenuation features are made available for media items that satisfy attenuation quality metrics.

### FIELD OF THE INVENTION

This disclosure relates generally to media playback and more specifically to providing a system and method for music playback with vocal track reduction.

### BACKGROUND

Media consumption is a frequent use of electronic devices. Users can use many types of electronic devices to access, collect, stream, and download their favorite music for playback. In current times, it can be preferable to partake in an interactive experience with media items. As an example, a user may wish to sing along with their favorite music.

### BRIEF DESCRIPTION OF THE DRAWINGS

FIG. 1 shows, in block diagram form, a simplified network diagram according to one or more embodiments.

FIG. 2 shows, in flow chart form, an example method for media track suppression, according to one or more embodiments.

FIG. 3 shows, flow chart form, an example method for media track quality analysis in accordance with one or more embodiments.

FIG. 4 shows, in flow chart form, an example method for media track quality analysis for a collection of media items, according to one or more embodiments.

FIG. 5 shows an example graphical user interface in accordance with one or more embodiments.

FIG. 6 shows an example system diagram for an electronic device in accordance with one or more embodiments.

### DETAILED DESCRIPTION

This disclosure is directed to systems, methods, and computer readable media for providing music playback with vocal reduction. In general, techniques are disclosed to provide audio signal processing to separate tracks of a media file having an audio component. Additionally, techniques are disclosed to provide a vocal attenuation feature for media items having an audio component on a user device. In some embodiments, the user device may be a mobile computing device, a tablet computing device, or the like.

According to one or more embodiments, the disclosed technology addresses the need in the art to provide media playback with vocal attenuation. In one embodiment, a user device provides audio playback of media files, such as songs, while enabling a user to adjust volume levels of separate tracks of media files. For example, during playback of a song, a user is enabled to adjust the volume of a vocal track, an accompaniment track, or both.

According to one or more embodiments, the disclosed technology addresses the need in the art to provide attenuation of a media item, or a collection of media items, on a client media device. The media item may include one or more audio components, such as vocals and accompaniment (e.g., instrumentals).

According to one or more embodiments, the disclosed technology may include a model that flags media content based on one or more quality control metrics. The model may include a vocal suppression model that extracts, for example, instrument-only or accompaniment components of a media file. The extracted instrument-only components may be analyzed, or processed, by a model to predict a quality score for the media file. The predicted score may be subjective, objective, or a combination thereof. In some embodiments, a media item may be provided with a quality label. When the predicted quality score for a media file is below a threshold, vocal attenuation for the media file is disabled. When above the threshold, vocal attenuation for the media file is enabled. The threshold may, in some embodiments, may be a pre-defined threshold. The pre-defined threshold for a media file's quality may be defined as a perceptual quality metric. In some embodiments, the perceptual quality metric threshold may be determined through human experimentation and/or feedback.

According to one or more embodiments, the attenuation quality model may consider additional factors that may affect or influence attenuation quality for a media item. Additional factors may include, but are not limited to, a media item's genre (e.g., classical, jazz, rock, pop), length of media item being under or below a certain threshold (e.g., ten seconds), or content not including music (e.g., spoken word, nature sounds, sound effects).

According to one or more embodiments, a media item may be displayed on a graphical user interface. The graphical user interface may include a graphical depiction for a media item, such as a song, a music track, or the like. Additionally, a collection of media items may be displayed on the graphical user interface. A collection of media items may include, for example, one or more songs of an album, a playlist, or the like. In addition, according to one or more embodiments, the graphical depiction for the media item, or collection of media items, may be denoted with an icon. The icon may provide a visual indication to a user via the graphical user interface. In some embodiments, the icon may indicate that a vocal attenuation feature is available for the media item. Additionally, or alternatively, the icon may indicate that a vocal attenuation feature is available for the collection of media items. In another embodiment, the icon may indicate that a vocal attenuation feature is available for a subset of media items of the collection of media items. In some embodiments, the icon may be a selectable icon. When selected, the icon may initiate a vocal attenuation feature for the associated media item or media items. The vocal attenuation feature may be performed by an application running on a user's device or on another device (e.g., server, cloud-based). In the alternative, the vocal attenuation feature may be a service provided by an operating system, such as a mobile operating system.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow chart may be presented in a particular order. However, it should be understood that the particular flow of any flow diagram is used only to exemplify one embodiment. In other embodiments, any of the various components depicted in the flow chart may be deleted, or the components may be performed in a different order, or even concurrently. In addition, other embodiments may include additional steps not depicted as part of the flow chart. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of image capture having the benefit of this disclosure.

For purposes of this disclosure, media items are referred to as “songs.” However, in one or more embodiments, the media items referred to as “songs” could be any kind of media item, such as audio media items, video media items, visual media items, textual media items, podcasts, interviews, radio stations, and the like.

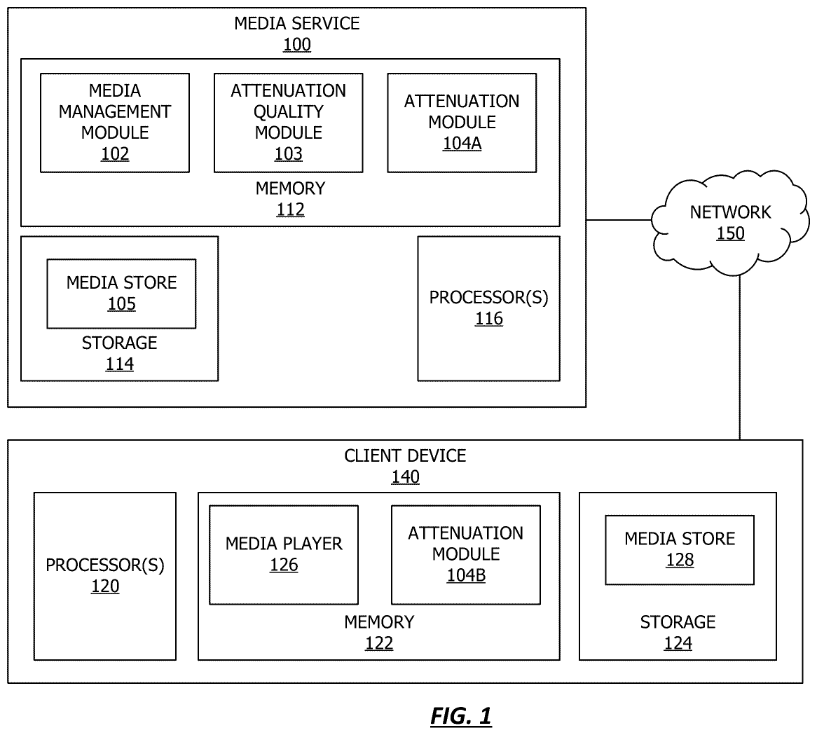

Referring to FIG. 1, a simplified block diagram is depicted of a media service 100 connected to a client device 140, for example over a network 150. Client device 140 may be a multifunctional device, such as a mobile phone, tablet computer, personal digital assistant, portable music/video player, wearable device, or any other electronic device that includes a media playback system.

Media service 100 may include one or more servers or other computing or storage devices on which the various modules and storage devices may be contained. Although media service 100 is depicted as comprising various components in an exemplary manner, in one or more embodiments, the various components and functionality may be distributed across multiple network devices, such as servers, network storage, and the like. Further, additional components may be used, some combination of the functionality of any of the components may be combined. Generally, media service 100 may include one or more memory devices 112, one or more storage devices 114, and one or more processors 116, such as a central processing unit (CPU) or a graphical processing unit (GPU). Further processor 116 may include multiple processors of the same or different type. Memory 112 may each include one or more different types of memory, which may be used for performing device functions in conjunction with processor 116. For example, memory 112 may include cache, ROM, and/or RAM. Memory 112 may store various programming modules during execution, including media management module 102, attenuation quality module 103, and attenuation module 104A.

Media service 100 may store media files, media file data, music catalog data, information regarding, for example, songs, albums, artists and creators, publishers, or the like. Additional data may include, but is not limited to, media file attenuation quality data (e.g., quality metrics, thresholds), model training data (e.g., attenuation model training data, attenuation quality model training data), and quality flag data. Media service 100 may store this data in a media store 105 within storage 114. Storage 114 may include one or more physical storage devices. The physical storage devices may be located within a single location, or may be distributed across multiple locations, such as multiple servers. The media files may include label data for indicating availability of vocal attenuation and may be stored in a media store 105. In one or more embodiments, label data may include information regarding songs or other media items, such as music videos, indicating availability, or unavailability, of vocal attenuation. Additionally, or alternatively, label data may include information regarding a full album or collection of songs, indicating availability, or unavailability, of vocal attenuation.

In another embodiment, media store 105 may include model training data for creating a dataset to train a model, such as attenuation quality module 103. Model training data may include labeled training data that a machine learning model uses to learn and then be enabled to predict a quality score for media items. In some embodiments, training data may consist of data pairs of input and output data. For example, input data may include media items that been processed along with a corresponding quality label. The quality label may be objective or subjective. Additionally, the quality label may be obtained through detailed experimentation with human listeners. An objective label may, for example, indicate a quality measure obtained by computing a classic source separation metric. A subjective label may, for example, indicate a perceptual quality score that is assigned by a human annotator.

In another embodiment, media store 105 may include model training data for creating a dataset to train a model, such as attenuation module 104A of media service 100 or attenuation module 104B of client device 140. Model training data may include labeled training data that a machine learning model uses to learn and then be enabled to extract instrument-only components of a song. In some embodiments, training data may consist of data pairs of input and output data. For example, input data may include songs with instrumental accompaniment and vocals (e.g., mix), and output data may include songs without vocals (e.g., instrumental). Candidate pairs of a music catalog may include pairs of songs (Song-1, Song-2) when one or more of the following parameters is met: a) Song-1 and Song-1 are by the same artist or creator; b) Song-1 and Song-2 are metadata equivalent (e.g., they appear on the same album); c) Song-1 and Song-2 are about the same length in seconds (+/−1 second); d) one of Song-1 and Song-2 is tagged as being instrumental; and e) neither Song-1 nor Song-2 is within a pre-defined excluded genre (e.g., comedy, sound effects, karaoke).

Returning to the media service 100, the memory 112 includes modules that include computer readable code executable by processor 116 to cause the media service 100 to perform various tasks. As depicted, the memory 112 may include a media management module 102, an attenuation quality module 103 and an attenuation module 104A. According to one or more embodiments, the media management module 102 manages a library or catalog of media content. The library may be user-specific, such as specific to a user of client device 140. Media management module 102 may provide media content upon request from a client device, such as client device 140.

Memory 112 also includes an attenuation quality module 103. In one or more embodiments, the attention quality module 103 may include a machine learning model that includes a quality flagger tool used to estimate the quality of voice-suppressed songs. The quality flagger tool may then assign a flag to a media item based on this estimation, where the flag is positive if the resulting audio is of good quality when voice, or vocals, of the media item are suppressed. Alternatively, a negative flag may be assigned to the media item if the resulting audio is of bad quality when voice, or vocals, of the media item are suppressed. The model of the attenuation quality module may be trained using training datasets as described herein. The quality flagger tool may use the model to predict a score for the media item based on the quality of the media item when the media item is played back with vocals being suppressed. Quality for a voice-suppressed media item may be based on a multiple factors including, but not limited to, audible artifacts or the presence of vocals that are still partially audible. Quality thresholds may be pre-defined by a user of the system.

In some embodiments, attenuation quality module may predict quality metrics for a collection of media items, such as an album or a playlist. In one example, all songs of an album may be given a positive flag and enabled for voice attenuation, except for one. In this example, the presence of one song having a negative flag may be considered undesirable, especially if the one song was assigned a quality score just below the threshold applied to the songs of the album. This may be rectified by determining a ratio between approved songs of the album and the number of songs of the album. When this ratio is above a coverage threshold (e.g., 80%), then the quality score of the negative flagged track is compared with the quality threshold to obtain a difference. When this difference is below a tolerance threshold (i.e., reduced quality is slightly lower) or otherwise compared against a second threshold value (i.e., a lower threshold than the first threshold), then the flag may be changed for the media item from negative to positive, causing the song to be considered available for vocal attenuation. In some embodiments, this adjusted flag using the second threshold or tolerance threshold maybe utilized in an album experience context. That is, if the song at issue is experienced in isolation apart from the album, the song may remain unflagged for voice attenuation, whereas the song may be flagged for voice attenuation when experienced in the context of the album (i.e., if the user is listening to other songs from the same album consecutively, within a same listening session, or the like).

Additional metrics may be considered by the quality flagger tool when evaluating a media item. These additional metrics may include, but are not limited to, the media item having a duration below 10 seconds, the media item belonging to a pre-defined set of excluded genres (e.g., classical, instrumental), or the media item's content does not include music (e.g., spoken word, nature sounds, sound effects).

Memory 112 also includes an attenuation module 104A. In one or more embodiments, the attention module 104A may include a machine learning model for attenuating certain audio components of a media file, such as isolating a vocal track in a song that includes vocals and instrumental accompaniment. In some embodiments, the attenuation module may be configured to receive an audio item and output a modified version of the audio item with separately modifiable audio tracks. That is, the audio tracks to not need to be pre-isolated in accordance with some embodiments.

The model for attenuating vocals may be created using training dataset as described herein. In some embodiments, the attenuation module may be provided on a user's mobile device, such as attenuation module 104B of client device 140. Further, the attenuation module 104 can be used to adjust audio characteristics of a media item received from a network device, locally obtained or stored on the client device, or the like. The attenuation module may be used to provide playback of a media item, such as a song, with reduced, or attenuated, vocals via a mobile device with high quality instrumental accompaniment. In some embodiments, the attenuation module provides functionality to allow a user to modify sound characteristics of the attenuated track in isolation from the remainder of the audio item to which the isolated track belongs. As an example, the user can reduce the volume of the vocal track of a song without reducing the volume of the remainder of the audio components for the song. Similarly, in some embodiments, the attenuation module may allow a user to modify the sound characteristics of the remainder of the media item while maintaining the audio characteristics of the isolated portion.

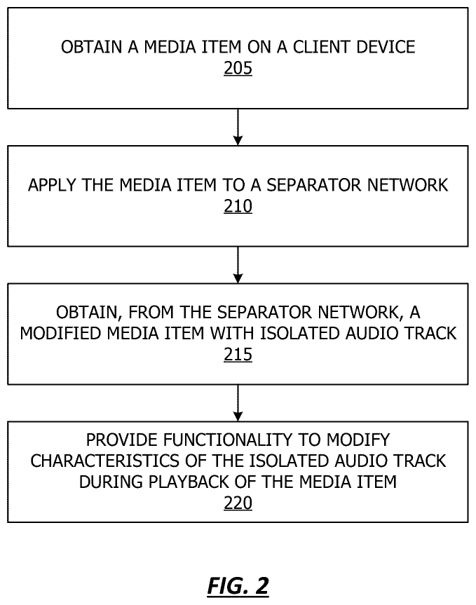

FIG. 2 shows, in flow chart form, an example method for attenuating a media item. The method may be implemented by attenuation module 104B on a client device, such as client device 140 of FIG. 1. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

The flow chart begins at 205 where the media player 126 obtains a media item on a client device 140. According to one or more embodiments, the media item may be obtained from a media service, as shown in FIG. 1. The media item may include at least one audio component comprised of vocals (e.g., singing) with instrument accompaniment.

The flow chart continues at 210 where the media item is applied to a source separation method to generate isolated audio tracks (e.g., vocal, instrumental). As an example, the media item may be applied to a In some embodiments, the media item may be applied to an artificial neural network to perform a source separation method and separate the entire background (i.e. accompaniment) from the vocals. The neural network may generate ideal masks to separate target sources, such as the background or the vocals. In some embodiments, the technique includes providing a modified media item such that at least part of the media item (i.e., a particular audio track such as a vocal track) is separately modifiable than the remainder of the media item.

The flow chart continues at 215 where the media player 126 obtains the modified media item from the source separation process. The modified media item may include one or more isolated audio tracks, such as a background instrument accompaniment track and a vocal track. The modified media item may be stored, for example, by the client device 140, in media store 128 of storage 124.

The flow chart continues at 220 where the media player 126 provides functionality to modify characteristics of the isolated audio track(s) during playback of the media item. In some embodiments, a listener may be provided with a user interface component such as a volume slider to adjust volume levels of a media item during playback. The listener would then be able to effectively reduce volume and listen to only the instrumental accompaniment portion of a song (e.g., a sing-along feature). Alternatively, the listener may adjust the instrument portion to a lower setting and increase the vocal track during playback. In some embodiments, printed lyrics of the vocal track may be shown to the listener. For example, lyrics may be shown on a portion of the listener's device in time with the media item during playback.

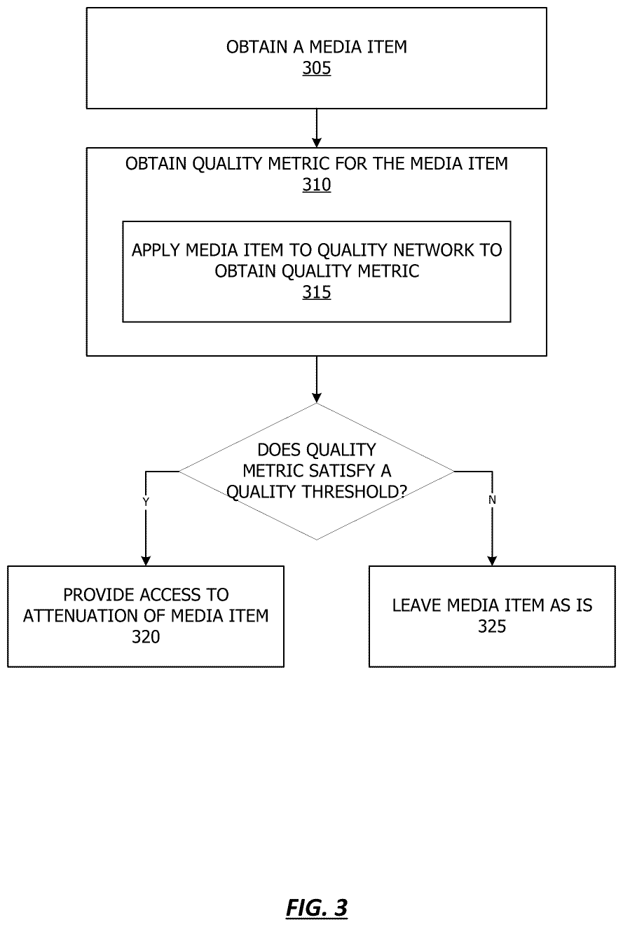

In some embodiments, an initial determination may be made as to whether to provide attenuation for a particular media item. FIG. 3 shows, flow chart form, an example method for generating a quality flag for a media item that includes at least one audio component. A quality flag may indicate media items for which vocal attenuation is provided in accordance with a prediction that the media item is suitable for attenuation. The method may be implemented by attenuation quality module 103 on a media service device, such as media service device 100 of FIG. 1. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

The flow chart begins at where the module 103 obtains a media item. In one example, the media item may be obtained from media store 105 of storage 114. The media item may include a purely audio media item, or a media item that includes an audio component, such as a video item or the like. The media item may include an audio component comprised of vocals and instrumental accompaniment.

The flow chart continues to 310 where the module 103 obtains a quality metric for the media item. The quality metric provides an indication as to whether the media item should be considered suitable, and therefore made available, for a vocal attenuation feature described herein. In some embodiments, the quality metric may be provided in the form of a positive flag, or in some value that indicates the suitability of the media item for attenuation. The quality metric may be provided in a number of ways, such as user-generated, based on a set of quality parameters applied to the media item, or the like.

In some embodiment, as shown at 315, the module 103 applies the media item to a quality network (e.g., an artificial neural network) having a machine learning model to predict the quality metric. The quality metric may be a score assigned to a media file predicting how a human listener would perceive the media item when heard with vocal attenuation enabled (e.g., would they perceive the media item positively or negatively?). In some embodiments, the quality network may provide a value representing a predicted percentage of users who would find the media item suitable for attenuation.

The flow chart then determines if the quality metric satisfies a quality threshold. The quality threshold may indicate the level of acceptability for a media file when listened to sans vocals. If the quality metric satisfies the threshold, then the flowchart continues to block 320 and access is provided to attenuation of the media item. For example, the media item may be available for attenuation at a playback device, and/or playback of the media item may be associated with user interface components by which a user can independently modify audio characteristics of a particular portion of the media item separately from the remainder of the media item in accordance with an attenuation. If the quality metric does not satisfy the threshold, the media item is left as-is 325 and the media item is not provided with attenuation features.

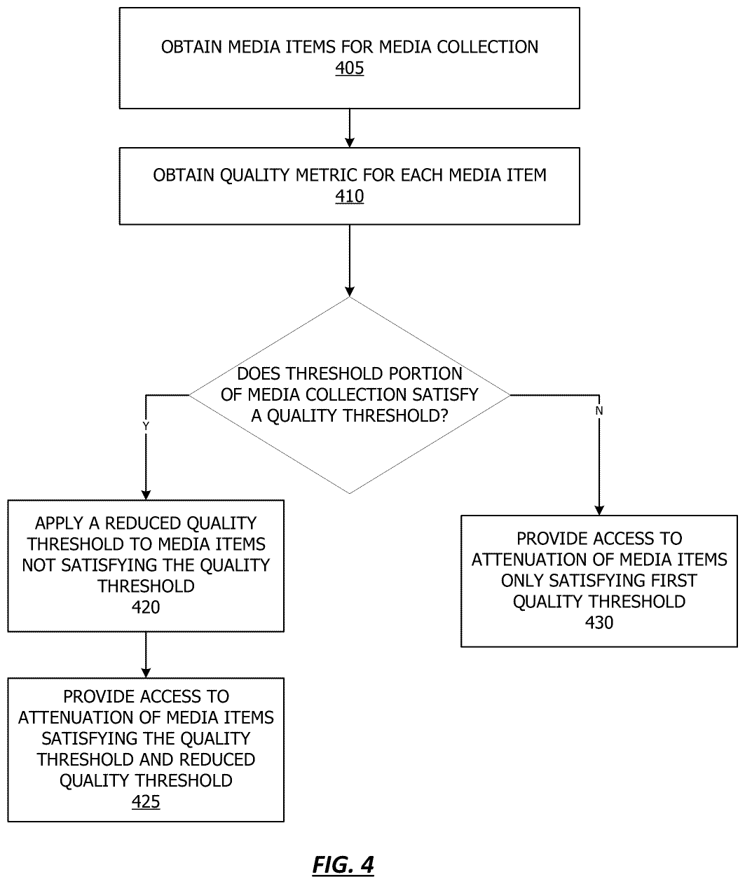

According to some embodiments, attenuation of media items may be provided based on a quality metric. However, in some embodiments, a tolerance threshold, or secondary threshold, may also be utilized in certain contexts, such as a particular song in the context of an album. FIG. 4 shows, flow chart form, an example method for generating a quality flag for a collection of media items that includes at least one audio component. The method may be implemented by attenuation quality module 103 on a media service device, such as media service device 100 of FIG. 1. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

The flow chart begins at block 405 where media items are obtained for a media collection. The media collection may include a set of media items provided as part of a collection, such as a record, a series, or the like. In some embodiments, the media items may be obtained in the context of a device requesting playback of one or more media items from a media collection.

The flowchart 400 continues at block 410 where a quality metric is obtained for each of the media items. The quality metric may be provided in the form of a value which is representative of a quality level of the media item with respect to attenuation (i.e., will the media item work well for attenuation). In some embodiments, the quality metric may be obtained from user-provided values, by applying rule-based parameters to determine a value, or by applying the media items to a network which is trained to predict a quality metric.

At block 415, a determination is made regarding whether a threshold portion of the media collection satisfies a quality threshold. As described above, whether attenuation is provided for an individual media item may be based on a quality threshold. In some embodiments, at block 415, the determination is made regarding what portion of the media items in the collection satisfied the quality threshold. The threshold portion may indicate a percentage or share of the collection for which a reduced threshold, or tolerance threshold, should be applied to the remainder of the items (i.e., the items not satisfying the quality threshold) in order to provide access to attenuation for more items among the collection, for example to improve the interactive experience of the collection. Accordingly, if a threshold portion does not satisfy a quality threshold, then the flowchart concludes at block 430, and attenuation is provided only for those media items of the collection for which the media items satisfied the quality threshold.

Returning to block 415, if a determination is made that a threshold portion of the media items is satisfied, then the flowchart continues to block 420 and a reduced quality threshold is applied to the remainder of the media items. For example, if the media items individually must have a quality threshold of 0.6 in order for attenuation to be provided, and 8 of 10 songs in an album have at least a 0.6 quality metric (compared to say, a 70% threshold portion), then the remaining two songs may be compared against a 0.5 quality threshold.

The flowchart concludes at block 425 where access to the attenuation is provided to those media items that either satisfied the original quality metric, or the reduced quality metric. That is, the 8 songs having at least a 0.6 quality metric could be provided with attenuation functionality. In addition, if either of the remaining 2 songs in the album satisfied the reduced threshold of 0.5, then they would also be provided along with the attenuation functionality.

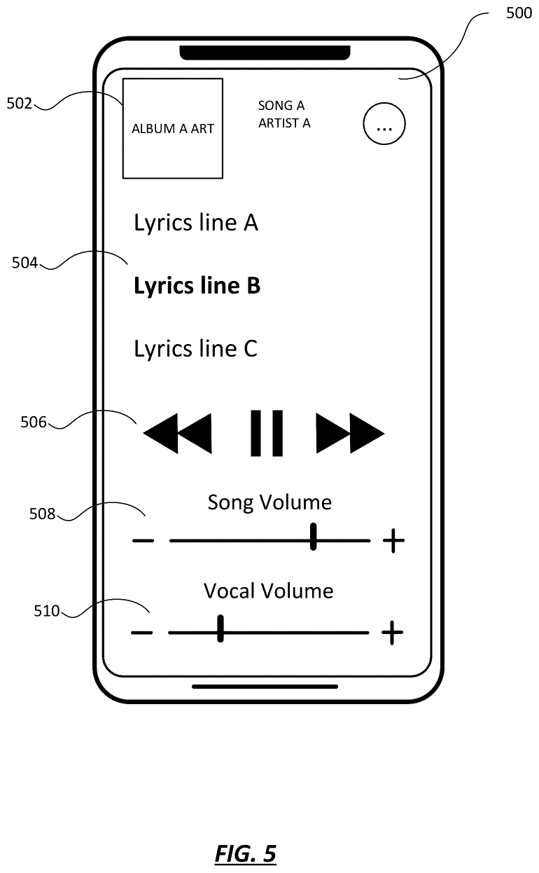

FIG. 5 shows an example graphical user interface in accordance with one or more embodiments. Specifically, FIG. 5 illustrates a multifunctional device 500 having a touch screen that displays media content, such as within media player 126 of FIG. 1. The media management module 102 may generate a graphical user interface that includes a graphical depiction 502 for one or more songs or other media items. Graphical depictions may include album art or a depiction of the artist. The graphical depiction for the one or more songs may be modified or enhanced with a graphical indication of whether attenuation is available for the one or more songs. In another embodiment, a graphical indication may be provided to indicate whether attenuation is available for a collection of media items, such as a playlist, an album, or the like. In at least one embodiment, the graphical indication may be a selectable icon. Upon selection of the vocal attenuation indicator, vocal attenuation for the corresponding song or track may be initiated, as described above. During playback of a media item, with vocal attenuation, lyrics may be displayed in portion 504. In some embodiments, lyrics may be displayed based on timestamp data of the media item. Playback controls 506 may be provided to the user, such as pause, rewind, or fast-forward of the media item during playback. Characteristics of the media item during playback may also be controlled, as shown in portions 508 and 510. During playback of a media item with vocal attenuation, the user may manipulate a slider to control volume levels of the song, or instrumental, portion of the media item. Additionally, or alternatively, the user may manipulate a slider to control volume levels of the vocal portion of the media item. Manipulating may be received as input from the user via a touchscreen, such as by tapping the “+” to increase volume or by tapping the “−” to decrease volume of either the song or the vocals. Alternatively, the user may manipulate volume levels by sliding their finger left and right on the slider to decrease/increase volume levels accordingly, for example.

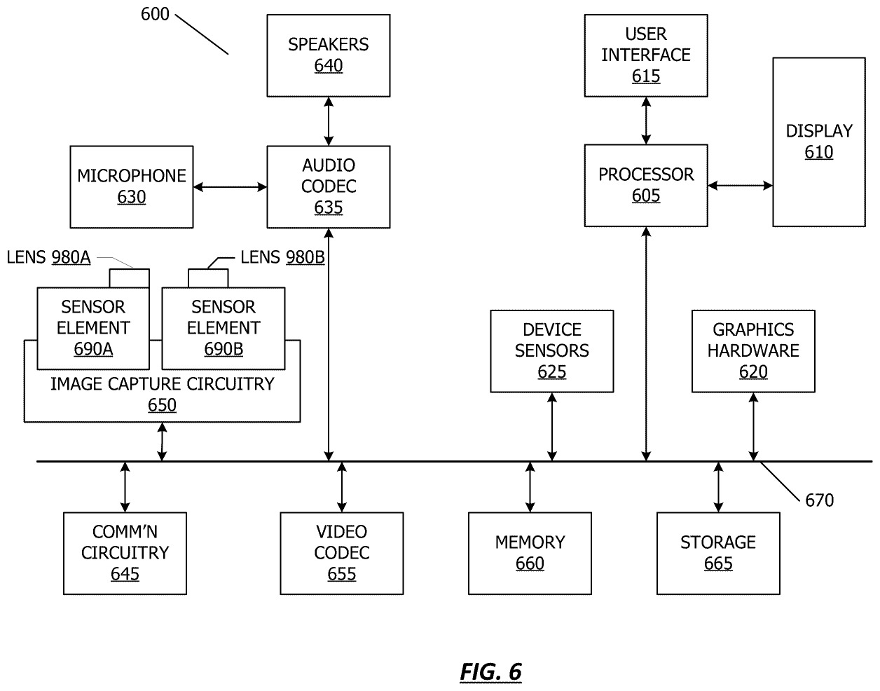

Referring now to FIG. 6, a simplified functional block diagram of illustrative multifunction device 600 is shown according to one embodiment. Multifunctional device 600 may show representative components, for example, for devices of media service 100, media service 100, and client device 140 of FIG. 1. Multifunction electronic device 600 may include processor 605, display 610, user interface 615, graphics hardware 620, device sensors 625 (e.g., proximity sensor/ambient light sensor, accelerometer and/or gyroscope), microphone 630, audio codec(s) 635, speaker(s) 640, communications circuitry 645, digital image capture circuitry 650 (e.g., including camera system) video codec(s) 655 (e.g., in support of digital image capture unit), memory 660, storage device 665, and communications bus 670. Multifunction electronic device 600 may be, for example, a digital camera or a personal electronic device such as a personal digital assistant (PDA), personal music player, mobile telephone, or a tablet computer.

Processor 605 may execute instructions necessary to carry out or control the operation of many functions performed by device 600 (e.g., such as the generation and/or processing of images as disclosed herein). Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen and/or a touch screen. Processor 605 may also, for example, be a system-on-chip such as those found in mobile devices and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still and/or video images. Output from image capture circuitry 650 may be processed, at least in part, by video codec(s) 655 and/or processor 605 and/or graphics hardware 620, and/or a dedicated image processing unit or pipeline incorporated within circuitry 665. Images so captured may be stored in memory 660 and/or storage 665.

Sensor and camera circuitry 650 may capture still and video images that may be processed in accordance with this disclosure, at least in part, by video codec(s) 655 and/or processor 605 and/or graphics hardware 620, and/or a dedicated image processing unit incorporated within circuitry 650. Images so captured may be stored in memory 660 and/or storage 665. Memory 660 may include one or more different types of media used by processor 605 and graphics hardware 620 to perform device functions. For example, memory 660 may include memory cache, read-only memory (ROM), and/or random access memory (RAM). Storage 665 may store media (e.g., audio, image and video files), computer program instructions or software, preference information, device profile information, and any other suitable data. Storage 665 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to tangibly retain computer program instructions or code organized into one or more modules and written in any desired computer programming language. When executed by, for example, processor 605 such computer program code may implement one or more of the methods described herein.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A method, comprising:
obtaining, from a media service, a media item;
applying the media item to a separator network;
obtaining, from the separator network, a modified media item having an isolated audio track; and
receiving selection of the media item for playback.

2. The method of claim 1, further comprising:
providing functionality to modify one or more characteristics of the isolated audio track during playback of the media item.

3. The method of claim 2, wherein the one or more characteristics include volume output of the isolated audio track during playback of the media item.

4. The method of claim 1, wherein the isolated audio track is a vocals track.

5. The method of claim 1, wherein the media item includes instrumental and vocals.

6. The method of claim 1, wherein a graphical representation of the media item includes at least one graphical indicator.

7. The method of claim 6, wherein the at least one graphical indicator indicates that vocal attenuation is available for the media item.

8. The method of claim 1, wherein the media item is a song.

9. The method of claim 1, wherein the media item is an album.

10. A method, comprising,
obtaining a media item;
obtaining at least one quality metric for the media item;
applying the media item to a quality network to obtain the at least one quality metric; and
determining if the at least one quality metric satisfies a quality threshold.

11. The method of claim 10, further comprising:
enabling access to a vocal attenuation feature when the at least one quality metric satisfied the quality threshold.

12. The method of claim 10, further comprising:
disabling access to a vocal attenuation feature when the at least one quality metric is below the quality threshold.

13. The method of claim 10, wherein the media item includes at least one audio component.

14. The method of claim 10, wherein the quality threshold is a pre-defined quality threshold.

15. A method, comprising,
obtaining a plurality of media items for a media collection;
obtaining a quality metric for each of the plurality of media items;
determining if a threshold portion of the media collection satisfies a quality threshold.

16. The method of claim 15, further comprising:
in response to determining that the threshold portion is below a quality threshold, only enabling access to a vocal attenuation feature for media items of the plurality of media items having quality metrics above the quality threshold.

17. The method of claim 15, further comprising:
applying a reduced quality threshold to media items of the plurality of media items having quality metrics below the quality threshold; and
enabling access to a vocal attenuation feature for media items of the plurality of media items having quality metrics above the quality threshold and the reduced quality threshold.

18. The method of claim 17, wherein the quality threshold and the reduced quality threshold are pre-defined thresholds.

19. The method of claim 15, wherein the media collection is an album.

20. The method of claim 15, wherein the media collection is a playlist.
